(19) United States
(12) Patent Application Publication
(10) Pub. No.: US 2008/0240662 A1
(43) Pub. Date: Oct. 2, 2008

(54) Optical cable for connection to a general distribution network, and a method of connecting said cable

(76) Inventor: Real Helvenstein, Harmignes (BE)

Correspondence Address: SOFER & HAROUN LLP., 317 MADISON AVENUE, SUITE 910, NEW YORK, NY, 10017, US

(21) Appl. No.: 12/077,186

(22) Filed: Mar. 17, 2008

(30) Foreign Application Priority Data
Mar. 16, 2007 (FR) 07 56145
Mar. 16, 2007 (FR) FR 07 53876

(51) Int. Cl. G02B 6/44

(52) U.S. Cl. 385/106

(57) ABSTRACT

The present invention relates to an optical cable comprising: one or more main optical fiber modules, each comprising optical fibers and an outer sheath, the optical fibers of each main module being surrounded by said outer sheath; and a protective covering surrounding said main optical fiber module(s); wherein: n main optical fiber modules, where n is an integer such that 1≦n≦3, are disposed inside a tube that is specific thereto, said n main modules being free inside said tube; and said cable further comprises a carrier element inside said protective covering; each of said tubes being held stationary between said carrier element and said protective covering.

### RELATED APPLICATION

This application claims the benefit of priority from French Patent Application No. FR 07 53876, filed on Mar. 16, 2007, the entirety of which is incorporated by reference.

This application is related to a co-pending patent application, filed contemporaneously under attorney docket number 979-358.

### FIELD OF THE INVENTION

The present invention relates to an optical cable for connection to a general distribution network, and also to a method of connecting said cable.

### BACKGROUND OF THE INVENTION

The invention applies particularly, but not exclusively, to the field optical cables for connecting a plurality of feed points to said general distribution network.

By way of example, the feed points may be located on subscriber premises or in branch-connection boxes for feeding branch networks.

Document FR 2 887 639 discloses an optical cable structure 1 as shown in FIG. 1.

The optical cable 1 comprises main optical fiber modules 11, 12, 13, and 14, with these modules together being surrounded by a closed protective covering 2a of circular section and presenting an inside surface 2b.

Each main module 11, 12, 13, or 14 has an outer sheath 110 and a plurality of optical fibers 111 contained within the outer sheath 110, said outer sheath 110 being made of a material that presents a low coefficient of dynamic friction.

The main optical fiber modules are arranged within the protective covering 2a in such a manner as to allow them sufficient clearance to make it easy to extract them.

The clearance is such that the area constituted by the sum of the sections of all of the main optical fiber modules contained within the protective covering 2a is less than 75% of the area of the section defined by the inside surface 2b of the protective covering.

These characteristics make it easy to extract each main module 11, 12, 13, or 14 from the optical cable 1 and to push a long length of the main module into a microconduit up to a connection point.

The typical method of making connections by means of this optical cable is also described in document FR 2 887 639.

In a first step, a first opening is formed in the protective covering 2a in a first zone and with the help of a dedicated tool. The first opening gives access to the main optical fiber modules 11, 12, 13, and 14 contained in the protective covering 2a.

One of the main optical fiber modules 11 that is to be diverted towards a feed point is selected and is then sectioned in the proximity of the first opening.

In a second step, a second opening is formed in the protective covering 2a in a second zone along the optical cable 1 and remote from the first zone.

In a third step, a portion of said main module 11 is extracted. For this purpose, the main module 11 is pulled through the second opening so as to extract the section portion of the main module 11.

In a fourth step, the portion of the main module 11 is inserted into a microconduit by being pushed, pulled, or blown along the preinstalled microconduit.

The microconduit extends between the main conduit in which the optical cable 1 is laid and a feed point on subscriber premises or in a branch-connection box.

Nevertheless, during the above-described third connection step, the way the main optical fiber modules 11, 12, 13, and 14 are arranged within the protective covering 2a of the optical cable 1 presents the drawback of tangling and of jamming in spite of the presence of the outer sheaths 110 having a low coefficient of dynamic friction.

Furthermore, the slightest infiltration into the inside of the optical cable 1, in particular due to damage to the protective covering 2a, is certain to make it difficult to extract said main modules.

Infiltration, e.g. of mud, into the inside of the optical cable 1 generally leads to the main optical fiber modules 11, 12, 13, and 14 clumping together, thus making them difficult to extract.

Consequently, it becomes very difficult to extract a long length of main optical fiber module, to perform multiple extractions of different main optical fiber modules from within a single optical cable, and thus to connect them easily to respective feed points.

Thus, the technical problem to be solved by the subject matter of the present invention is to propose an optical cable comprising one or more main optical fiber modules, each comprising optical fibers and an outer sheath, the optical fibers in each main module being surrounded by said outer sheath, said optical cable serving to avoid the problems of the state of the art, in particular preventing the main optical fiber modules from tangling while being connected to feed points.

According to the present invention, the solution to the technical problem posed lies in that n main optical fiber modules, where n is an integer such that 1≦n≦3, are disposed inside a tube that is specific thereto, said n main modules being free inside said tube; and in that said cable further comprises a carrier element inside said protective covering; each of said tubes being held stationary between said carrier element and said protective covering.

The term “main module” is used to mean any optical fiber module that can be extracted from the optical fiber over a long length, for example up to about 100 meters, for the purpose of connection to feed points, e.g. located on subscriber premises or in branch-connection boxes for feeding respective branch networks.

By means of the present invention, the n main modules of each tube are isolated from the n other main optical fiber modules, or in other words each of the tubes isolates its n main modules from the n main modules of the other tubes, thereby significantly limiting any risk of the main modules tangling while they are being connected.

The tubes also protect the n main modules from any clumping that could be caused by mud infiltrating into the inside of the optical cable, thereby guaranteeing optimized extraction of said n main modules.

In addition, each main module can slide inside the tube and can be extracted easily from said tube since the n main modules are arranged within the cavity of the tube with sufficient.

Furthermore, the carrier element enables the disposition of the tubes around said element to be organized so as to have easy and fast access to said tubes when connecting the main modules.

Finally, the tubes being held stationary has the advantage of making it easier to extract the n main modules from the inside of each tube.

This facilitates connecting main optical fiber modules to various feed points.

Advantageously, n is equal to 1, or in other words each main optical fiber module is disposed within a tube that is specific thereto.

Thus, each main optical fiber module is completely isolated from the other optical fiber modules, thereby preventing them from tangling while they are being connected.

This significantly optimizes the extraction of main optical fiber modules.

### OBJECTS AND SUMMARY OF THE INVENTION

In a particular embodiment, the area of the section(s) of the main module(s) is less than 80% of the area of the section of the inside surface of the tube.

The n main modules can thus easily be extracted from their tube, in particular by a blowing method.

In another particular embodiment, the tube(s) are twisted around the carrier element.

It is possible to use any type of configuration, or in other words any type of twisting, well known to the person skilled in the art, in particular a helical configuration of the S or of the Z type, or a reversed oscillation configuration of the S-Z type.

An S-Z type configuration for the tube(s) around the carrier element is particularly preferred since it gives easier and quicker access to the various tubes around the carrier element.

According to a characteristic of the present invention, the carrier element is a reinforcing element giving good mechanical strength to the optical cable.

For example, the reinforcement element is of the core type being made of optionally-sheathed metal or of reinforced fiber plastics (FRP).

In a variant, the carrier element may itself also be an internal optical cable having at least one internal optical fiber module, and also serving to reinforce the optical cable of the present invention.

In a particularly preferred embodiment, at least one internal optical fiber module of the internal cable is connected to at least one of the main optical fiber modules, these modules naturally being modules that are interposed between the internal optical cable and the protective covering of the optical cable.

The end of the internal optical cable can thus be connected to the main optical fiber modules by connection means, thus providing a “end loop” so as to enable two different portions of a single main module to be extracted during operations of making connections to feed points.

At one end of the cable, the optical fibers of the internal modules of the internal cable can thus advantageously be connected to the optical fibers of the main optical fiber modules to provide continuity of optical transmission in said optical cable.

In other words, this constitutes an end loop.

By way of example, the connection means between the main and the internal modules may be implemented by welding or by means of a mechanical connector.

In another variant, the carrier element may also be either an optical fiber, or a main or internal module, or a tube optionally containing at least one optical fiber or a module, these various types of carrier element being as described in the present invention.

In a preferred embodiment, all of the main modules surrounding said carrier element of the optical fiber, module, or tube type may be supported by metal or composite (FRP) cores, in order to reinforce the structure of the optical cable.

In another preferred embodiment, the tube is made of a polybutylene terephthalate (PBT) and a polycarbonate (PC).

Nevertheless, material of said tube is not limited in any way to that type of polymer and it may be made of other thermoplastic polymers that are thermally stable.

In addition, the tube may advantageously include a coloring agent and/or inscriptions on its outer surface making it easier to select tubes visually when making connections with the main modules.

Thus, the coloring agent, like the inscriptions, do not in any way harm the integrity of the main optical fiber modules.

In another particular embodiment, the outer sheath of the main module is made up of a polymer material that is filled so as to make it easy to tear.

By way of example, the polymer may be a polyolefin, in particular a polymer and/or a copolymer of ethylene, or a polyester.

In another embodiment, the protective covering comprises at least one layer of a material of the polyolefin, polyester, or polyamide type.

In a variant, the protective covering comprises an outer layer an inner layer.

Preferably, the outer layer is made of a high density polyethylene and the inner layer is made of support strands, said support strands possibly being of the polyester or aramid type.

In addition, an intermediate layer of armoring type, e.g. of corrugated steel, can be interposed between the outer layer and the inner layer.

Typically, the various layers making up the protective covering must be easy to cut in order to give access to the tubes.

The present invention also provides an optical cable comprising one or more optical fiber modules, each including at least one optical fiber, the main module(s) being surrounded by an outer sheath, and a protective covering surrounding said main optical fiber module(s).

Said optical fiber further comprises an internal optical cable inside said protective covering, said internal optical cable comprising at least one internal optical fiber module.

In order to enable two different portions of a single main module to be extracted during connection operations, it is advantageous for at least one internal optical fiber module of the internal optical cable to be connected to at least one of the main optical fiber modules of the optical cable.

The present invention also provides a method of connection using an optical cable of the present invention, the method comprising the following steps:
selecting a tube of the optical cable and sectioning it in a first zone of said cable, and then sectioning a main module of said tube in the first zone;
sectioning said tube in a second zone of the cable, the second cable being remote from the first zone;
extracting the sectioned portion of the main module from the tube that is specific thereto at the second zone by means of a blowing operation; and
connecting a feed point to the optical cable using the extracted main module portion.

In a particularly advantageous implementation, said main module is extracted from its tube by injecting a stream of air from the first section zone of the tube.

In a particular implementation, the connection method includes a step consisting in making an opening in the protective covering in the first and/or the second zone.

### BRIEF DESCRIPTION OF THE DRAWINGS

Other characteristics and advantages of the present invention appear in the light of the following description of non-limiting examples of an optical cable of the present invention, and given with reference to the accompanying figures, in which:

FIG. 1 is a diagram showing a prior art optical cable structure in cross-section;

FIG. 2 is a diagram showing the structure of an optical cable in accordance with the present invention in cross-section;

FIG. 3 is a diagram showing another structure of an optical cable in accordance with the present invention in cross-section;

FIG. 4 is a diagram showing another structure of an optical cable in accordance with the present invention, in cross-section; and

FIG. 5 is a diagram showing how main optical fiber modules are extracted from the optical cable of FIG. 3 or FIG. 4.

### MORE DETAILED DESCRIPTION

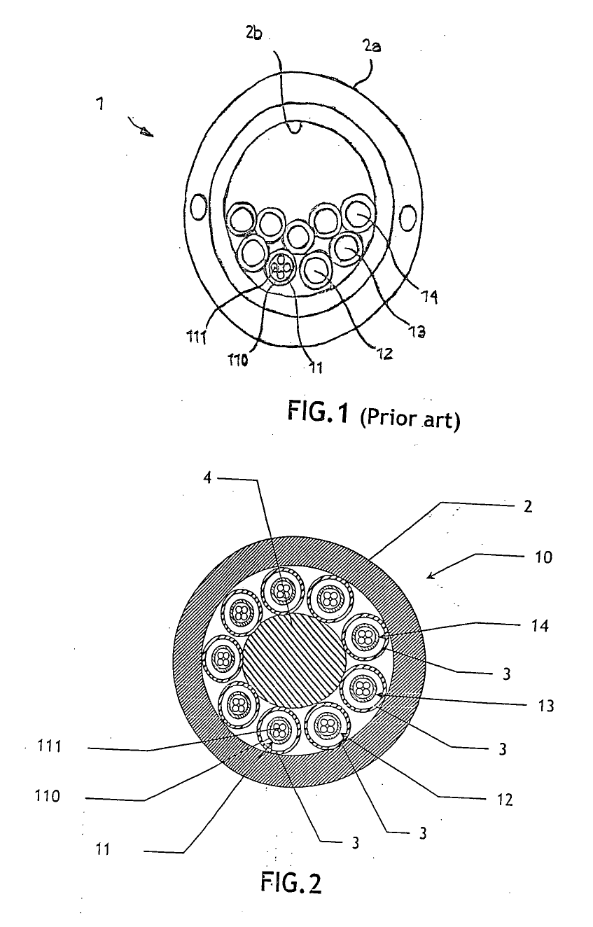

FIG. 1 is described above, and to facilitate understanding, elements that are common between the present invention and the prior art are given the same references.

FIG. 2 is a section view of an optical cable 10 constituting a particular embodiment of the present invention.

The cable 10 includes nine main optical fiber modules 11, 12, 13, 14 and a protective covering 2 surrounding said main optical fiber modules.

Each main module comprises an outer sheath 110 surrounding optical fibers 111.

The term “main optical fiber module” is used to mean one or more optical fibers, preferably a number in the range 1 to 16, surrounded by an outer polymer sheath that is not necessarily tight around the optical fibers so that it can easily be removed.

The optical fibers typically have a diameter of 250 micrometers (μm).

Each main module extends inside a tube 3 that is specific thereto, said main module being free inside said tube.

For example, the diameter of the main module 11 is about 1.1 millimeters (mm) and the inside diameter of the tube 3 is about 1.7 mm, the area of the section of said main module thus being less than 80% of the section area of the inside surface of said tube.

The cable further includes a central carrier element 4 of the fiber-reinforced plastics (FRP) type extending inside the protective covering 2.

This central position makes the optical cable more compact and makes it easier to organize the main modules around said carrier element.

In another embodiment (not shown), the carrier element is not necessarily at the center of the cable.

Thus, a plurality of entities comprising main optical fiber modules associated with a carrier element can extend within the protective covering of an optical cable of the present invention.

The essential function of the carrier element 4 is to organize the various main optical fiber modules at its periphery.

As shown in FIG. 2, each tube 3 is in contact with the outside surface of the carrier element 4 and is held by the protective layer 2.

Naturally, it is not essential for all of the tubes to be in contact with the carrier element and with the protective covering 2, in particular with its inside surface.

For example, they might be in contact either with the carrier element 4 or with the inside surface of the protective covering 2.

It is essential only for the tubes 3 to be interposed between the protective layer 2 and the carrier element 4 in order for them to be held stationary.

The tubes are preferably wound around the carrier element using an S-Z type twist, which facilitates access to each tube during extraction of the main optical fiber modules.

This type of winding is performed in alternation on tube segments of successive lengths, with twisting to the left (S twisting) and twisting to the right (Z twisting).

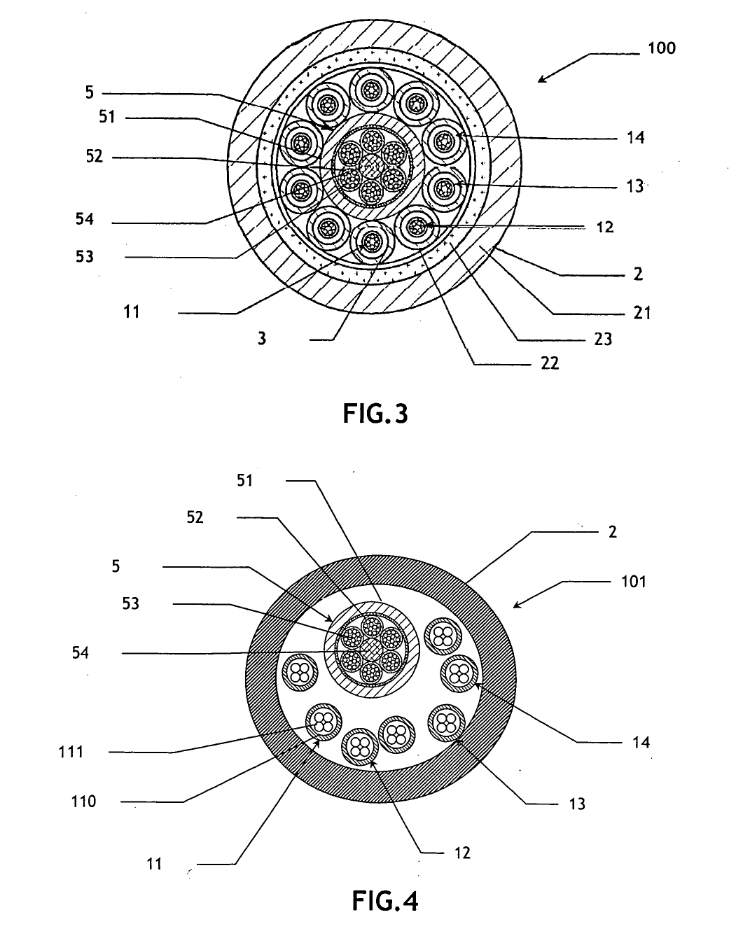

FIG. 3 is a section view of an optical cable 100 constituting another particular embodiment of the present invention.

In particular, it presents a possible variant for the protective covering and for the carrier element, the other component elements of the optical cable 100 remaining identical to those described with reference to FIG. 2.

As shown in FIG. 3, the protective covering 2 of said optical cable 100 is constituted by an outer layer 21 and an inner layer 22.

By way of example, the outer layer 21 is made of high density polyethylene and the inner layer 22 is a set of supporting strands, e.g. of polyester.

An intermediate layer 23 of armoring type made of corrugated steel is interposed between the outer layer 21 and the inner layer 22.

The carrier element is itself an internal optical cable 5. Said internal optical cable 5 is not necessarily used for delivering information to feed points, or in other words it is not necessarily used by extracting long lengths thereof for making connections to said points.

The various tubes 3 are held between the protective outer layer 51 of said internal optical cable 5 and the inner layer 22 of the protective covering 2.

This internal optical cable 5 also comprises a plurality of internal optical fiber modules 52, each internal module comprising a plurality of optical fibers 53.

The component elements of each internal module may advantageously be identical to the component elements of the main module.

Said internal optical cable 5 also has a rigid central element 54 extending inside said internal optical cable 5.

The outer layer 51 surrounds all of the internal modules 52 and the rigid central element 54, and it can be made of a material of the same type as that used for the protective covering 2.

FIG. 4 is a section view of an optical cable 101 constituting another particular embodiment of the present invention.

Identically to above-described FIGS. 2 and 3, the optical cable 101 comprises main optical fiber modules 11, 12, 13, 14, with all of said main modules being surrounded by a protective covering 2 surrounding said main optical fiber modules.

Each main module comprises an outer sheath 110 surrounding optical fibers 111, each main module being as described above in the present invention.

Said outer sheath 110 may be made of a material presenting a low coefficient of dynamic friction, as described in document FR 2 887 639.

The optical cable 101 also comprises an internal optical cable 5 inside said protective covering 2, said internal optical cable 5 being as described above with reference to FIG. 3.

Said internal optical cable 5 includes at least one internal module 52 of optical fibers 53.

At least one internal optical fiber module 52 of the internal optical cable 5 is connected to at least one of the main optical fiber modules 11, 12, 13, 14 of the optical cable 101.

The main optical fiber modules 11, 12, 13, 14 are typically arranged inside the protective covering 2 in such a manner as to possess sufficient clearance to make them easy to extract.

The clearance is such that the area of the sum of the sections of all of the main optical fiber modules contained in the protective covering 2 and of the internal optical cable 5 is less than 80% of the section area of the inside surface of the protective covering 2.

These characteristics preferably make it easier to extract each main module 11, 12, 13, 14 from the optical cable 101 and to push a long length of the main module along a microconduit to a connection point.

The techniques used for extracting and connecting said main modules may be those that are described in document FR 2 887 639.

The numbers of main and/or internal modules 11, 12, 13, 14, 52 and the numbers of optical fibers 111, 53 shown in FIGS. 2, 3, and 4 are naturally not limiting in any way.

The preferred connection method for said optical cable of the present invention is of the “tapping” type as described in patent document FR 2 887 639.

In a first step, a first opening is made in the protective covering 2 in a first zone using a dedicated tool.

This opening gives access to the tubes 3 contained inside the protective covering 2.

One of the tubes 3 containing a main module 11 is selected, said main module being the module that is it desired to divert to a feed point.

The tube 3 of the main module 11 is sectioned close to the first opening in the optical cable 10, 100 in order to give access to said main module.

In a second step, a second opening is made in the protective covering 2 in a second zone and with the help of a dedicated tool.

The tube of the main module 11 is sectioned close to the second zone of the optical cable in order to access said main module 11, the second zone being remote from the first zone.

The distance between the first and second zones along the optical cables 10, 100 typically lies in the range a few meters to a few tens of meters, but it may be as great as about 100 meters.

In a third step, the main module 11 is pulled from the second zone so as to extract the sectioned portion of said main module.

Said portion of the main module 11 is advantageously extracted from the second zone of the cable by injecting a stream of air into the inside of said tube from said first zone where the tube 3 is sectioned.

In a fourth step, a feed point is connected to the optical cable 10, 100 using the extracted main module portion.

When applying the so-called “tapping” method to the optical cable 100, 101 as shown respectively in FIGS. 3 and 4, the internal optical cable 5 advantageously enables the main optical fiber modules to be fed so as to make it possible to perform two connection operations on different portions of a single main optical fiber module.

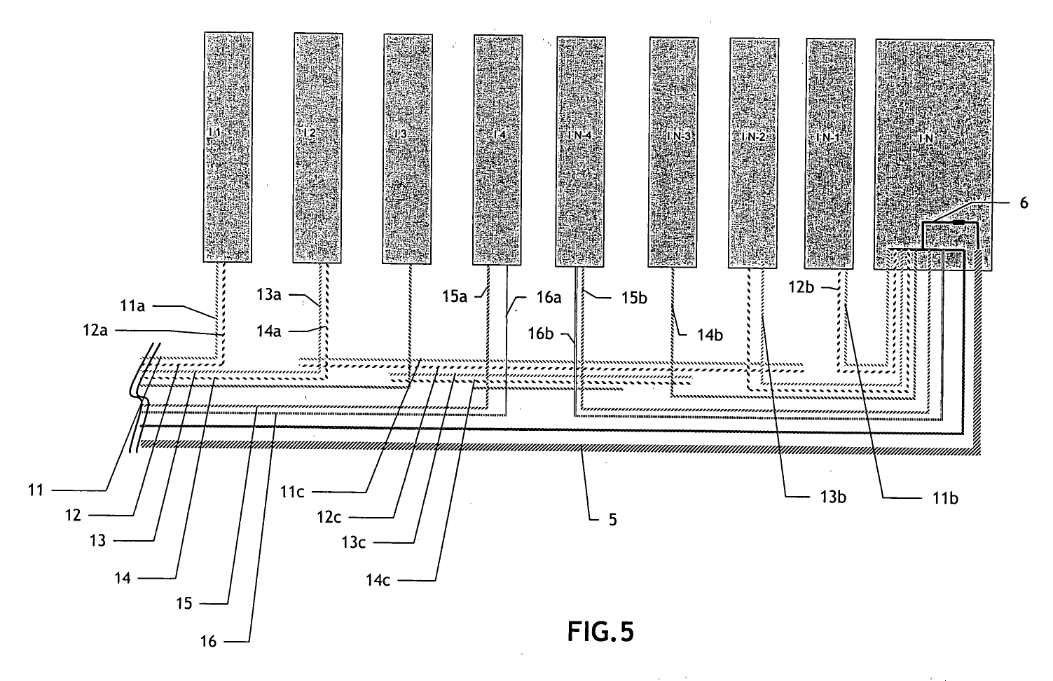

This duplicated use of a main optical fiber module is made possible when the internal modules 52 of the internal optical cable 5 are connected, at one end of the optical cable 100, 101, to the main optical fiber modules of the optical cable 100, 101 by connection means 6 in order to form a connection loop, as shown in FIG. 5.

In other words, and more generally, at least one optical fiber 53 of an internal module 52 of the internal optical cable 5 is connected to an optical fiber 111 of a main module 11, 12, 13, 14 of the optical cable 100, 101.

FIG. 5 is a diagram showing an example of how various main modules 11 to 16 can be connected to N buildings I1 to IN.

First connection operations, performed by the tapping method as described above, serve to connect a portion 11a of the main module 11 to building I1, to connect a portion 12a of the main module 12 to the building I1, to connect a portion 13a of the main module 13 to the building I2, to connect a portion 14a of the main module 14 to the building I2, to connect a portion 15a of the main module 15 to the building I4, and to connect a portion 16a of the main module 16 to the building I4.

Because of the loop via the connection means 6 between the internal optical cable 5 and the main modules 11 to 16, located in building N, second connection operations can also be performed by tapping other portions of the same main modules 11 to 16.

Thus, the second connection operations serve to connect another portion 11b of the main module 11 to building IN-1, to connect another portion 12b of the main module 12 to the building IN-1, to connect another portion 13b of the main module 13 to the building IN-2, to connect another portion 14b of the main module 14 to the building IN-2, to connect another portion 15b of the main module 15 to the building IN-4, and to connect another portion 16b of the main module 16 to the building IN-4.

The portions 11c, 12c, 13c, 14c of the main modules 11, 12, 13, 14 that are not used for connection purposes remain inside the optical cable 100, 101.

This end looping serves in particularly advantageous manner to enable only x/2 main optical fiber modules to be used to perform x connection operations.

The total number of main optical fiber modules between the internal optical cable and the protective covering can thus be limited to a significant extent.

Typically, the end of the optical cable opposite from the loop, i.e. the end from which the modules 11 to 16 are taken beside the building I1, is connected by way of example to a feed presence point for the optical cable (not shown in FIG. 5).

Such a presence point is well known to the person skilled in the art and serves to make connections to said optical cable in order to feed it optically.

The present invention is not limited to the optical cable examples described above and extends more generally to any optical cable that can be envisaged on the basis of the general indications in the description of the invention.

What is claimed is:

1. An optical cable comprising:
one or more main optical fiber modules, each having optical fibers and an outer sheath, the optical fibers of each main module being surrounded by said outer sheath; and
a protective covering surrounding said main optical fiber module(s), wherein
n main optical fiber modules, where n is an integer such that 1≦n≦3, are disposed inside a tube that is specific thereto, said n main modules being free inside said tube; and
said cable further includes a carrier element inside said protective covering, each of said tubes being held stationary between said carrier element and said protective covering.

2. A cable according to claim 1, wherein n is equal to 1.

3. A cable according to claim 1, wherein the area of the section of the n main modules is less than 80% of the area of the section of the inside surface of the tube.

4. A cable according to claim 1, wherein the tube(s) is/are twisted around the carrier element.

5. A cable according to claim 4, wherein the configuration of the tube(s) around the carrier element is of the S-Z type.

6. A cable according to claim 1, wherein the carrier element is a reinforcing element.

7. A cable according to claim 1, wherein the carrier element is an internal optical cable having at least one internal optical fiber module.

8. A cable according to claim 7, wherein at least one internal optical fiber module of the internal optical cable is connected to at least one of the main optical fiber modules of the optical cable.

9. A cable according to claim 1, wherein the tube is made of a polybutylene terephthalate and a polycarbonate.

10. A cable according to claim 1, wherein the tube includes a coloring agent.

11. A cable according to claim 1, wherein the outer sheath is made of a filled polymer material.

12. A cable according to claim 1, wherein the protective covering has an outer layer and an inner layer.

13. A cable according to claim 12, wherein the outer layer is made of high density polyethylene and the inner layer is made of supporting strands.

14. A cable according to claim 12, wherein an intermediate layer of the armoring type is interposed between the outer layer and the inner layer.

15. A method of connection using an optical cable as defined in claim 1, the method comprising the following steps:
selecting a tube of the optical cable and sectioning it in a first zone of said cable, and then sectioning a main module of said tube in the first zone;
sectioning said tube in a second zone of the cable, the second cable being remote from the first zone;
extracting the sectioned portion of the main module from the tube that is specific thereto at the second zone by means of a blowing operation; and
connecting a feed point to the optical cable using the extracted main module portion.

16. A method according to claim 15, wherein said main module is extracted from the tube that is specific thereto by injecting a stream of air from the first zone where the tube is sectioned.

17. A method according to claim 15, including a step of making an opening in the protective covering at the first and/or second zones.
